(19) United States
(12) Patent Application Publication
(10) Pub. No.: US 2026/0054629 A1
(43) Pub. Date: Feb. 26, 2026

(54) FOLDING TABLE, WALL ELEMENT, ARRANGEMENT, AND VEHICLE

(71) Applicant: Thor Tech, Inc., Elkhart, IN (US)

(72) Inventor: Tim Schüle, Waldburg (DE)

(73) Assignee: Thor Tech, Inc., Elkhart, IN (US)

(21) Appl. No.: 19/284,901

(22) Filed: Jul. 30, 2025

(30) Foreign Application Priority Data
Aug. 26, 2024 (DE) 10 2024 124 290.6

(51) Int. Cl. B60N 3/00; B60N 2/28; B60P 3/36

(52) U.S. Cl. CPC B60N 3/002; B60N 2/28; B60P 3/36

(57) ABSTRACT

A folding table, in particular for arrangement in a vehicle, comprising a table unit, wherein the table unit comprises a table top which is pivotable about a pivot axis (S′) so that the table top can be transferred from a folded state to an unfolded state and is connected to a support element, and a holding element on which the support element is arranged to be movable in a linear direction (L′), wherein the support element comprises at least one locking element which is designed to fix the table unit in the linear direction (L′) on the holding element.

### CROSS-REFERENCE TO RELATED APPLICATIONS

This application claims priority to German application No. 10 2024 124 290.6 filed Aug. 26, 2024, the disclosure of which is hereby incorporated by reference in its entirety.

### FIELD

The present invention relates to a folding table. Furthermore, the present invention relates to a wall element with such a folding table, an arrangement, and a vehicle, in particular a camping vehicle or motor home.

### BACKGROUND

Traditional tables or seating groups, e.g., for dining or for leisure activities, which are provided or suitable for arrangement in a vehicle, in particular a motor home or camping vehicle, are already known from the prior art. Traditional seating groups are, for example, tables with corner benches or standing tables. The familiar tables are usually fixedly or immovably arranged in the vehicle. Such a seating group is therefore not very suitable for use as a workplace, since these types of seating groups do not allow for ergonomic adjustment options. However, the need for such tables or workplaces in vehicles is increasing due to the growing demand for mobile work.

It has therefore become apparent that there is a need to provide an ergonomically adaptable workplace for a vehicle.

### SUMMARY

Therefore, it is an object of the present invention to provide a folding table that addresses the above problem and allows height adjustment. It is a further object of the present invention to provide a wall element, an arrangement, and a vehicle.

The object is achieved by the folding table having the features of claim 1, by the wall element having the features of claim 8, by the arrangement having the features of claim 9, and by the vehicle having the features of claim 10.

According to one aspect of the present invention, a folding table is provided, in particular for arrangement in a vehicle, comprising a table unit, wherein the table unit comprises a table top which is pivotable about a pivot axis so that the table top can be transferred from a folded state to an unfolded state and is connected to a support element, and a holding element on which the support element is arranged to be movable in a linear direction, wherein the support element comprises at least one locking element which is designed to fix the table unit in a linear direction on the holding element.

Compared to the known prior art, the present invention provides the advantage that the folding table is ergonomically adjustable and is provided for arrangement in a vehicle, in particular a camping vehicle. The folding table can be adjusted to a standing work position or sitting work position of a user. It is in particular advantageous that the folding table can be part of a modular system. For example, the folding table can be part of a modular wall element that can be connected to other wall elements. Furthermore, the present invention is advantageous because, in these ways, the limited space in a vehicle can be better utilized. The folding table according to the present invention can be folded or unfolded and adjusted in height with a few movements. This means that the folding table can be adapted to a user and set up and used only when needed.

The table unit includes the table top and the support element. The table top provides a support surface for work equipment, such as electronic devices. The table top is pivotably connected to the support element around the pivot axis. The support element supports the table top. The table top can be moved around the pivot axis by means of joint elements, in particular hinges. Preferably, the table top is connected to the support element at one edge of the support element. In an unfolded state, the table top is preferably arranged orthogonally to the support element. In the folded state, the table top is preferably arranged parallel to the support element. The table top and the support element can be made of a wooden material, a metal, and/or a plastic. Wooden materials are characterized by good processing options and a beautiful appearance. Metals have high strength and therefore resistance. Plastics are versatile, inexpensive, and easy to obtain.

The table unit is arranged on the holding element so that it can move linearly. A linear movement is understood to be a straight-line movement of the table unit. Preferably, the table unit is guided linearly in the holding element. In particular, the table unit is movable in a vertical direction. The vertical direction is understood to be a movement in the direction of gravity when the folding table is in an assembled state or in operation. The holding element is preferably at least partially connected to the table unit in a form-fit. Additionally or alternatively, the holding element and the table unit can be connected to each other in a force-fit.

The table unit has the locking element for locking the table unit in a desired position. This means that the table unit can be fixed. The table unit is preferably locked by a user. By means of the locking element, the table unit can be locked in the vertical direction or in height. The locking element preferably fixes the table unit by means of a form-fit and/or force-fit. It is conceivable that the table unit comprise several, e.g., two, locking elements.

In one embodiment, the locking element comprises a bolt element which is arranged on the support element and engages in recesses, in particular bores, in the holding element in order to fix the table unit. In particular, the bolt element can be designed as a spring bolt. The spring bolt has a spring that applies a restoring force to the bolt and holds it in one position. This allows the bolt to be loosened by hand in order to be transferred together with the table unit into a desired position, in which the bolt is then released.

In one embodiment, the holding element comprises a first guide element and the support element comprises a second guide element which have geometries corresponding to each other and are designed to enable movement of the table unit in the linear direction. For example, the first guide element and the second guide element can be designed as rail elements with corresponding profiles. By means of the guide elements, a defined guidance of the table unit along the linear direction is enabled. This also allows the spring bolt to be moved on a line with the corresponding holes.

In one embodiment, the first guide element comprises a linear recess that extends in a direction parallel to the linear direction, and the second guide element comprises a corresponding extension that engages in the linear recess. For example, the linear recess and the corresponding extension can have a dovetail-shaped geometry in cross-section. This allows the table unit to be moved in the linear direction and to be limited in a form-fit in a direction orthogonal to the linear direction.

In one embodiment, the holding element comprises two first guide elements, and the support element two second guide elements. The two first guide elements and the two second guide elements are each arranged parallel to each other. This allows more stable guidance of the table unit to be realized. The pairs of guide elements are arranged in such a way that they can interact with each other.

In one embodiment, the table unit comprises at least one support element that is connected to the table top and the support element, wherein the support element is designed to support the table top in the unfolded state. The support element can, for example, comprise a joint. Alternatively or additionally, the support element can be designed such that the support element can be retracted and extended telescopically. It is conceivable that the table unit comprise several, in particular two, support elements. This can increase the load-bearing capacity of the table unit in the unfolded state.

A further aspect of the present invention relates to a wall element with a folding table according to one of the preceding embodiments. A wall element is understood to be a building element that can be installed as a wall in a vehicle. The wall element preferably extends further in the linear longitudinal direction than in a transverse direction.

In one embodiment, the wall element comprises a connecting section that is designed for arranging a seat element. In one embodiment, the connecting section comprises at least one magnet which is part of a magnetic connection. Alternatively, the wall section can be designed to interact with a magnet to connect an object to the wall element. For example, a seat element can be arranged on the wall element in this manner such that it does not slip. In particular, the seat element can be secured in this manner during a journey.

In one embodiment, the wall element comprises at least one connection that is intended to provide energy. For example, the connection may comprise a power outlet and/or a USB port. The connection can, for example, be arranged near the floor when the wall element is in an installed state. It is conceivable that the wall element comprise one or more such connections.

In one embodiment, the wall element comprises at least one storage section that is designed to store work equipment, in particular electronic devices. Alternatively or additionally, the storage section can be designed to store non-electronic work equipment such as pens or paper. The storage section can include hooks or pockets, for example. The hooks or pockets can be firmly connected to the wall element, in particular formed integrally therewith.

In one embodiment, the wall element is part of a modular system that is designed to be arranged in a vehicle. This means that the wall element is connected or can be connected to other wall elements. The wall element can, for example, be arranged at any position in a vehicle. Accordingly, the wall element can be exchanged with another wall element or arranged in a different position in another vehicle.

In one embodiment, the wall element comprises a coupling section, wherein the coupling section is intended to coordinate with a further coupling section of a further wall element. The coupling section can additionally or alternatively coordinate with a vehicle wall in a form-fitting and/or force-fitting manner in order to fix the wall element. The coupling section can comprise coupling elements which coordinate with further coupling elements of the further coupling section of the further wall element. This allows several wall elements to be connected or coupled together.

A further aspect of the present invention relates to an arrangement comprising a wall element according to one of the preceding embodiments and a seat element, wherein the seat element is preferably connected to the wall element by means of a magnetic connection. Furthermore, the arrangement can comprise at least one wall element according to one of the preceding embodiments and a further wall element.

A further aspect of the present invention relates to a vehicle with a folding table according to one of the preceding embodiments, with a wall element according to one of the preceding embodiments or an arrangement according to the preceding embodiment. The vehicle can be a motorized vehicle, such as a camper van or minibus, or a non-motorized vehicle such as a travel trailer.

Individual features and embodiments can be combined with one another and thereby form new embodiments. Further developments and effects also apply analogously to the new embodiments. The designs and advantages that are mentioned with regard to the device also apply analogously to the method, and vice versa.

### BRIEF DESCRIPTION OF THE DRAWINGS

In the following, the present invention is described in detail with reference to the attached figures, in which:

FIG. 1 is a perspectival view of an embodiment of a folding table according to the invention;

FIG. 2 is a further perspectival view of the folding table according to FIG. 1 with a seat element;

FIG. 3 is a further perspectival view of the folding table according to FIG. 1;

FIG. 4 is a perspectival view of the folding table according to FIG. 1 from behind;

FIG. 5 is a perspectival view of a further embodiment of a folding table;

FIG. 6 is a perspectival view of the folding table according to FIG. 5 in an unfolded state; and

FIG. 7 is a detail view of the folding table according to FIG. 6.

### DETAILED DESCRIPTION

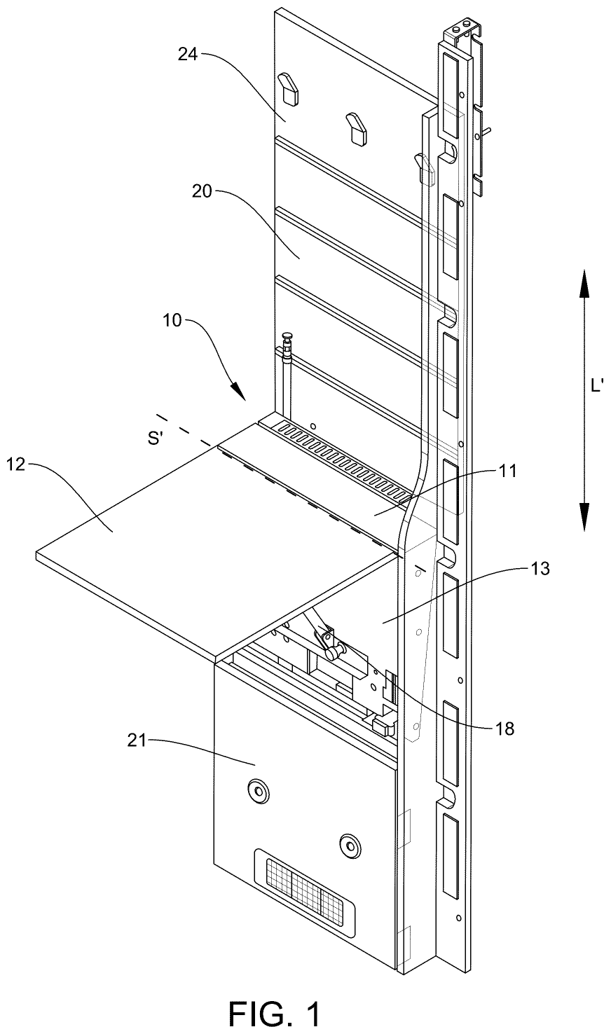

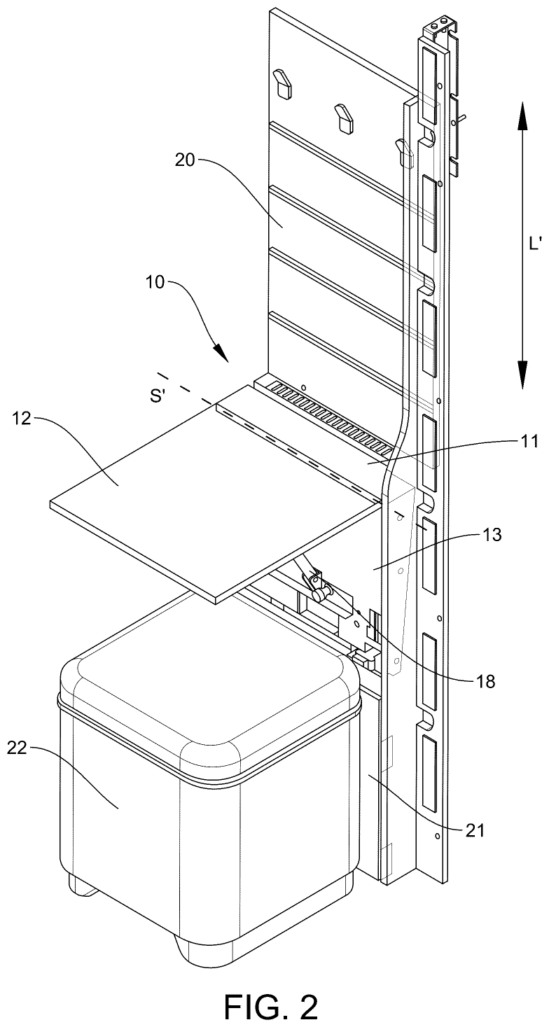

FIG. 1 shows a wall element 20 with a folding table 10 in the unfolded state. FIG. 2 shows the wall element 20 with the folding table 10 according to FIG. 1 with a seat element 22.

The wall element 20 comprises a frame 23 or is connected to the frame 23. The frame 23 serves for arrangement of the wall element 20 in the interior of a vehicle. The wall element 20 comprises a connecting section 21. The connecting section 21 is arranged at the bottom or near the floor when the wall element 20 is in an assembled state. The connecting section 21 has magnetic connecting means which are designed to interact with a corresponding connecting means of the seat element 22. This allows the seat element 22 to be connected to the wall element 20.

In the assembled state of the wall element 20 above the folding table 10, a storage section 24 is arranged. Three hook elements are arranged in the storage section 24. The hook elements are provided for hanging or storing bags or work equipment. Alternatively or additionally, other means of storage are conceivable.

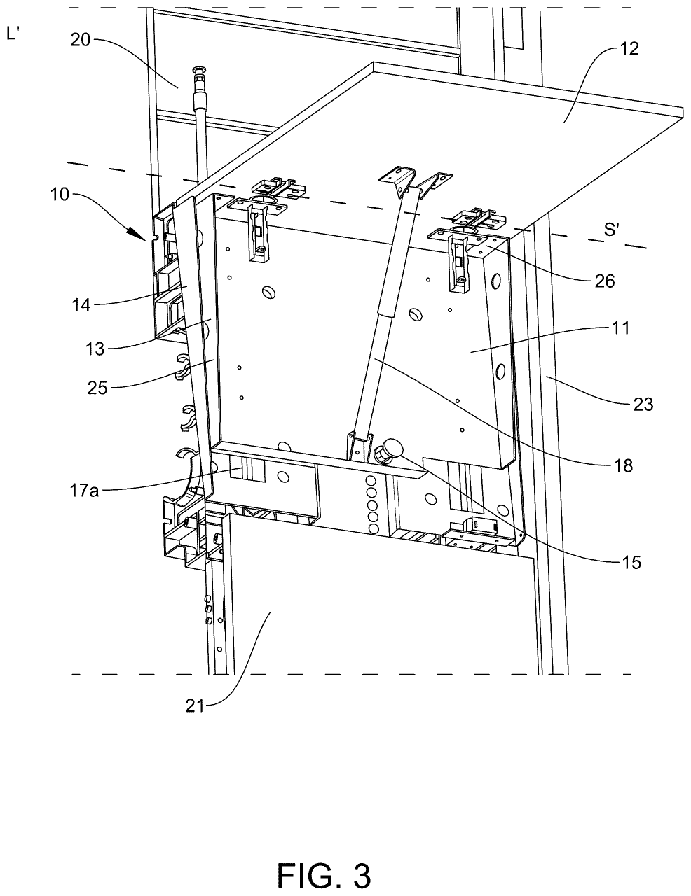

FIG. 3 shows a more detailed representation of the folding table 10 in the unfolded state. The folding table 10 comprises a table unit 11 and a holding element 14. The table unit 11 is arranged on the holding element 14. Stated more specifically, the table unit 11 is connected to the holding element 14 so as to be movable in a linear direction L′.

The table unit 11 comprises a table top 12 and a support element 13. The table top 12 can be pivoted about a pivot axis S′ and is connected to the support element 13. The table top 12 is connected to the support element 13. Furthermore, the table unit 11 has a support element 18.

The support element 18 is connected in each case to a bottom side of the table top 12 and a front side of the support element 13. The support element 18 has a joint at each of the axial ends which enables rotation about an axis parallel to the pivot axis S′. The support element 18 is designed to support the table top 12 in an unfolded state. Furthermore, the support element 18 is designed to enable the table top 12 to be folded in the direction of the support element 13. For this purpose, the shown support element 18 can be telescopically pushed into itself, at least sectionally. In an unfolded state, the table top is arranged parallel to the support element. Stated more precisely, in the linear direction L′, the underside of the table top 12 faces the front side of the support element.

The table top 12 is basically rectangular in shape. In an unfolded state, the table top 12 spans a right angle with the support element 13. The table top 12 has a movable section and a static section. The moving section and the static section are separated from each other by a gap. The movable section and the static section are connected to each other by hinges. The movable section can be rotated or pivoted about the pivot axis S′. The static section is firmly and immovably connected to the holding element 14.

The support element 13 has a substantially rectangular geometry. The support element 13 has a wing element 25 on each of two opposite sides parallel to the longitudinal direction L′. The wing elements 25 extend in the linear direction L′ along the entire support element. The wing elements 25 extend away from the support element 13. Stated more specifically, the wing elements 25 extend orthogonally to the linear direction L′ away from the support element. The wing elements 25 each have support surfaces 26. In the assembled state, the support surfaces 26 are arranged upwards in a linear direction L′. The support surfaces each form an axial end of the wing elements 25. The static section of the table top 12 is arranged on the support surfaces 26. The static section of the table top 12 is connected to the support element 13 via the support surface 26—for example, by means of screws.

A locking element 15 is also arranged in the support element 13. The locking element 15 is arranged centrally in the support element 13. The locking element 15 is positioned in an installed state in the linear direction L′, lower region of the support element 13. Stated otherwise, the locking element 15 is arranged on a side, remote from the table top 12, of the support element 13. The locking element 15 is designed as a spring bolt. The spring bolt extends through the support element 13 and engages through holes in the holding element 14 to fix the support element 13 in a position.

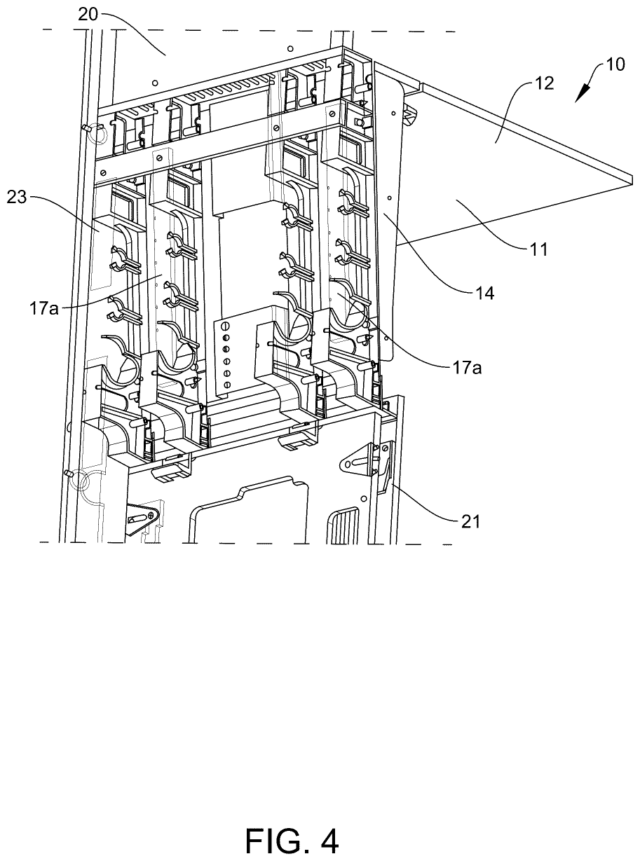

The holding element 14 has a substantially rectangular geometry. The support element 13 is movably connected to the holding element 14 in the linear direction L′. The holding element 14 has a larger surface than the support element 13 in order to accommodate the support element 13. The holding element 14 has two first guide elements 17a, and the support element 13 has two second guide elements 17b (not shown). The first guide elements 17a are designed as slide rails. The second guide elements 17b each have a geometry corresponding to the slide rails so that they are movably guided in the slide rails in the linear direction L′. The first guide elements 17a are clearly visible in FIG. 4, for example. The geometry, in particular the length, of the first guide elements 17a defines the distance that the table unit 11 can be displaced in the linear direction L′.

The holding element 14 has a U-shaped geometry in cross-section. The U-shaped geometry extends in the linear direction L′. The U-shaped geometry is arranged centrally in the holding element 14 in the transverse direction. The transverse direction is understood to be a direction orthogonal to the linear direction L′. The bores in which the spring bolt engages are arranged in the U-shaped geometry. The bores are arranged in an edge area of the U-shaped geometry. In the present case, the holding element 14 has six bores. Accordingly, the support element 13 can be locked in six different positions. Alternatively, more or fewer holes are conceivable.

The frame 23 is shown in FIG. 4. The frame 23 is part of the wall element 20. The frame includes connecting structures so that the wall element 20 can be mounted on an interior wall of a vehicle. Furthermore, the wall element 20 comprises a coupling section which is designed to connect the wall element 20 to another wall element 20.

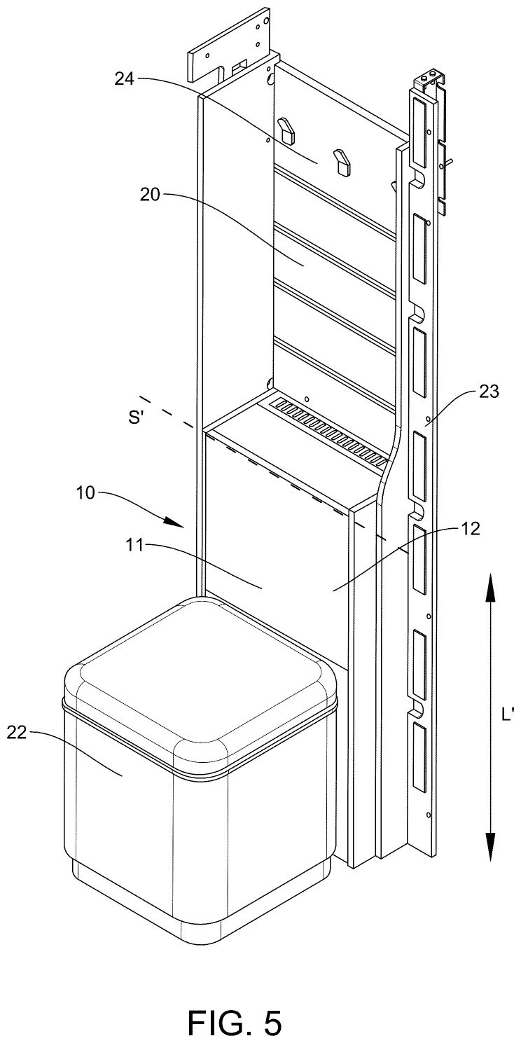

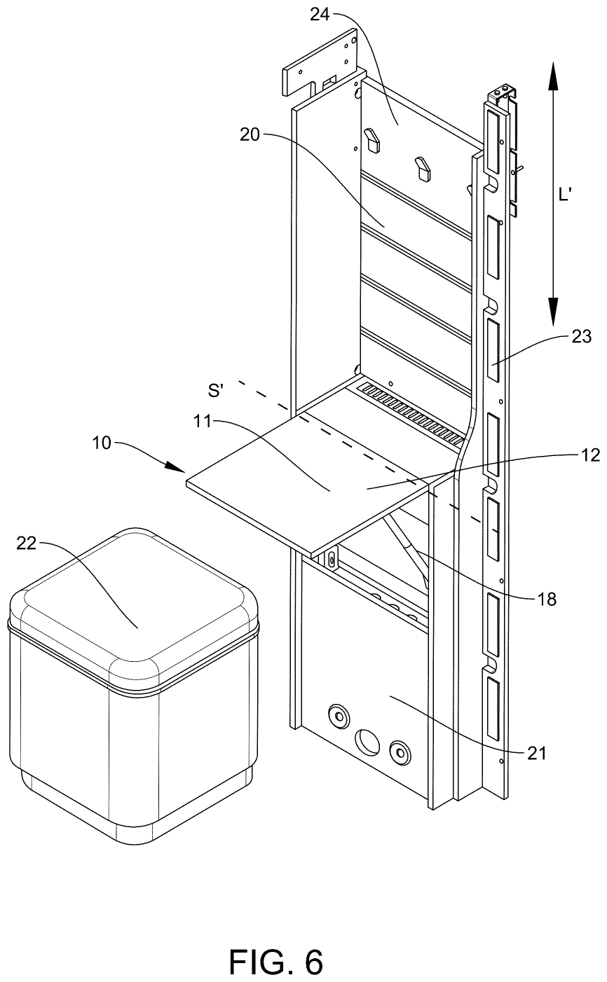

FIG. 5 shows a further embodiment of the wall element 20 with folding table 10. FIG. 5 shows a wall element 20 on which a seat element 22 is arranged at the connecting section 21. In FIG. 6, the folding table 10 is in an unfolded state, and the seat element 22 is arranged offset from the connecting section 21. In contrast to the embodiment according to FIG. 1, the wall element 20 has a side wall that extends perpendicularly away from the wall element 20. This means that the wall element 20 can be arranged, for example, in a corner area.

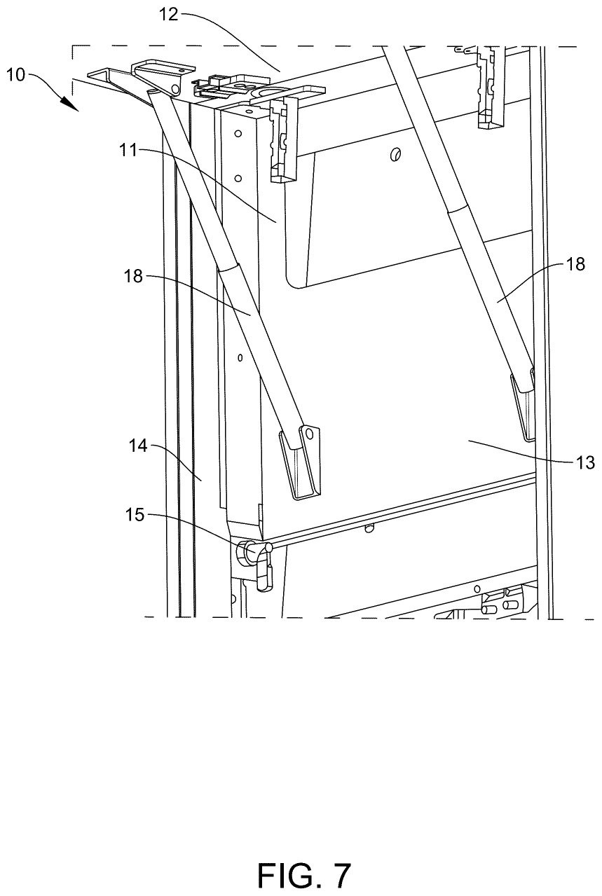

FIG. 7 shows the folding table 10 according to FIG. 5 and FIG. 6 in detail. The folding table 10 has two support elements 18. The support elements 18 correspond to the support element 18 shown in FIG. 3. The support elements 18 are arranged parallel to each other. The locking element 15 is arranged in a wing element 25 of the support element 13. Accordingly, the bores in the holding element 14 in which the locking element 15 engages are also arranged in a further wing element of the holding element 14.

A method for adjusting a folding table 10 can include the following steps. Releasing the locking element 15. Displacing the table unit 11 along the linear direction L′. When a desired position is reached, securing the table unit 11 by means of the locking element 15. In particular, the locking element 15 can remain in a released position by pulling. This means that, for example, a locking element 15 designed as a spring bolt is subjected to a tensile force during the displacement of the table unit 11. In order to fix the table unit 11 in a position, the spring bolt is no longer subjected to a tensile force, and the spring bolt is released so that it is moved into a closed position by a restoring force.

Other embodiments of the present invention are possible and can be understood and practiced by those skilled in the art in applying the claimed subject matter from a study of the figures, the disclosure, and the appended claims. In particular, the respective parts/functions of the respective embodiment described above can also be combined with one another. In the claims, the word “comprising” does not exclude other elements or steps, and the indefinite articles “a” or “an” do not exclude a plurality. The mere fact that certain measures are mentioned in claims dependent upon each other does not mean that a combination of those measures cannot be advantageous. Any reference signs in the claims should not be construed as limiting the scope of the claims.

1. A folding table, in particular for arrangement in a vehicle, comprising:
a table unit, wherein the table unit comprises a table top which is pivotable about a pivot axis (S′) so that the table top can be transferred from a folded state to an unfolded state, and is connected to a support element, and
a holding element on which the support element is arranged to be movable in a linear direction (L′), wherein the support element comprises at least one locking element which is designed to fix the table unit in the linear direction (L′) on the holding element.

2. The folding table according to claim 1, wherein the at least one locking element comprises a bolt element which is arranged on the support element and engages in recesses in the holding element in order to fix the table unit.

3. The folding table according to claim 1 wherein the holding element comprises a first guide element and the support element comprises a second guide element which have corresponding geometries and are designed to enable movement of the table unit in the linear direction (L′).

4. The folding table according to claim 3, wherein the first guide element comprises a linear recess that extends in a direction parallel to the linear direction (L′), and the second guide element comprises a corresponding extension that engages in the linear recess.

5. The folding table according to claim 3, wherein the holding element comprises two first guide elements and the support element comprises two second guide elements.

6. The folding table according to claim 1, wherein the table unit comprises at least one support element which is connected to the table top and the support element, wherein the at least one support element is designed to support the table top in the unfolded state.

7. A wall element with a folding table according to claim 1.

8. The wall element according to claim 7, wherein the wall element comprises a connecting section which is designed for arranging a seat element

9. An arrangement comprising a wall element according to claim 7 and a seat element, wherein the seat element is preferably connected to the wall element by means of a magnetic connection.

10. A vehicle comprising:
a folding table, wall element or an arrangement;
the folding table comprises:
a table unit, wherein the table unit comprises a table top which is pivotable about a pivot axis (S′) so that the table top can be transferred from a folded state to an unfolded state, and is connected to a support element, and
a holding element on which the support element is arranged to be movable in a linear direction (L′), wherein the support element comprises at least one locking element which is designed to fix the table unit in the linear direction (L′) on the holding element;
the wall element comprises the folding table; and
the arrangement comprises the wall element and a seat element,
wherein the seat element is preferably connected to the wall element by means of a magnetic connection.
